(19) United States
(12) Patent Application Publication
(10) Pub. No.: US 2023/0146244 A1
(43) Pub. Date: May 11, 2023

(54) Canister

(71) Applicants: Osaka Gas Chemicals Co., Ltd., Osaka-shi (JP); AISAN KOGYO KABUSHIKI KAISHA, Obu-shi (JP)

(72) Inventors: Kenji Seki, Osaka-shi (JP); Kunihisa Iwasaki, Osaka-shi (JP); Kazuki Sakai, Osaka-shi (JP)

(21) Appl. No.: 17/981,045

(22) Filed: Nov. 4, 2022

(30) Foreign Application Priority Data
Nov. 5, 2021 (JP) 2021-181457

(51) Int. Cl. B01D 53/04

(52) U.S. Cl. CPC B01D 53/0438; B01D 53/0415; B01D 2253/102; B01D 2253/304; B01D 2257/702; B01D 2259/402; B01D 2259/4516; B01D 2259/4566; B01D 2259/657; F02M 25/0854

(57) ABSTRACT

Provided is a canister that includes a first adsorbing layer K1 including a first adsorbing material Q1 as an adsorbing material Q and a second adsorbing layer K2 including, as the adsorbing material Q, a second adsorbing material Q2 different from the first adsorbing material Q1. The first absorbing layer K1 and the second absorbing layer K2 are provided inside a casing 10. In a flowing direction X of fuel vapor J between one end and another end of the casing 10, the first adsorbing layer K1 is disposed at a position in contact with an air port 10a at the other end, and the second adsorbing layer K2 is disposed closer to the one end than the first adsorbing layer K1 is. The first adsorbing material Q1 adsorbs the fuel vapor J at an adsorbing rate that is higher than an adsorbing rate of the second adsorbing material Q2.

### CROSS-REFERENCE TO RELATED APPLICATION

This application claims priority to Japanese Patent Application No. 2021-181457 filed Nov. 5, 2021, the disclosure of which is hereby incorporated by reference in its entirety.

### BACKGROUND OF THE INVENTION

### Field of the Invention

The present invention relates to a canister including: a casing internally provided with an adsorbing layer including an adsorbing material capable of adsorbing and desorbing fuel vapor; a tank port provided at one end of the casing and configured to allow the fuel vapor to flow into the casing; a purge port provided at the one end of the casing and configured to allow the fuel vapor to flow out of the casing; and an air port provided at another end of the casing and configured to allow air to flow into and out of the casing.

### Description of Related Art

There is a conventionally-known canister internally provided with an adsorbing layer that is capable of adsorbing and desorbing fuel vapor and is constituted by activated carbon, which is used as an adsorbing material, and a heat storage material including a phase change material that absorbs and releases latent heat according to temperature (see JP 2005-233106A).

For example, JP 2001-145832A and JP 2003-311118A disclose, as such a heat storage material including a phase change material, a powdery heat storage material obtained by encapsulating a phase change material such as an aliphatic hydrocarbon, which absorbs and releases latent heat along with a phase change, in microcapsules, and also disclose a latent-heat-storing adsorbing material that is obtained by mixing the powdery heat storage material with an adsorbing material and molding the mixture, or by affixing the powdery heat storage material to a surface of a granular adsorbing material (activated carbon).

JP 2005-233106A, JP 2001-145832A, and JP 2003-311118A are examples of related art.

In order to further improve adsorbing ability in the technique disclosed in JP 2005-233106A described above, it is conceivable to use activated carbon that has high adsorbing ability.

However, JP 2005-233106A does not disclose or suggest what kind of adsorbing material is to be provided at which position in a flowing direction of the fuel vaper to realize a canister that can exhibit high adsorptivity while suppressing an increase in the production cost, and there is still room for improvement.

### SUMMARY OF THE INVENTION

The present invention was made in view of the above issues, and has an object of providing a canister that can have high adsorbing ability and small size while maintaining economic efficiency by adjusting a position at which the length of an adsorption band of an adsorbing layer during adsorption is reduced, in a flowing direction in which fuel vapor flows within the canister while being adsorbed.

A canister for achieving the above object is a canister including:

a casing internally provided with an adsorbing layer that includes an adsorbing material capable of adsorbing and desorbing fuel vapor;

a tank port provided at one end of the casing and configured to allow the fuel vapor to flow into the casing;

a purge port provided at the one end of the casing and configured to allow the fuel vapor to flow out of the casing; and

an air port provided at another end of the casing and configured to allow air to flow into and out of the casing,

the canister being characterized in including:

a first adsorbing layer that is provided inside the casing, includes a first adsorbing material as the adsorbing material, and is disposed at a position in contact with the air port at the other end in a flowing direction of the fuel vapor between the one end and the other end; and

a second adsorbing layer that is provided inside the casing, includes, as the adsorbing material, a second adsorbing material different from the first adsorbing material, and is disposed closer to the one end than the first adsorbing layer is in the flowing direction,

wherein the first adsorbing material adsorbs the fuel vapor at an adsorbing rate that is higher than an adsorbing rate of the second adsorbing material.

In order to increase adsorbing ability particularly at the time when supplied fuel is adsorbed and to downsize the canister while suppressing an increase in the production cost of the canister, the inventors of the present invention focused on (i) an adsorbing rate at which an adsorbing material constituting an adsorbing layer adsorbs fuel vapor and (ii) the length (L in FIGS. 3(b) and 3(c)) of an adsorption band that indicates a region in a flowing direction of the fuel vapor in which the fuel vapor is being adsorbed (from the starting of adsorption to the adsorption limit), and completed the present invention.

Here, a relationship between an adsorbing rate and an adsorption amount of an adsorbing layer K (adsorbing material) including a first adsorbing layer and a second adsorbing layer will be described with reference to FIGS. 2 and 3(a). In FIGS. 2 and 3(a)-(c), the adsorbing layer K is divided into four regions (a region between X0 and X1, a region between X1 and X2, a region between X2 and X3, and a region between X3 and X4) in a flowing direction X in which fuel vapor J flows while being adsorbed, and adsorption amounts of the fuel vapor J adsorbed on the adsorbing material in the respective regions are expressed with color depths of triangle marks. A larger adsorption amount is expressed with a deeper color. Furthermore, the vertical axis in FIG. 2 shows time t, and FIG. 2 shows a process of adsorption of the fuel vapor J by the adsorbing layer K gradually progressing from a time t0 that is immediately before start of supply via a time t1 at which supply is started, to a time t2 at which supply is ended.

As shown in FIG. 2, when attention is paid to a predetermined position in the flowing direction X of the fuel vapor J in a case where the fuel vapor J is supplied to the adsorbing layer K, the adsorption amount of the fuel vapor J adsorbed on the adsorbing layer K increases as time elapses from the start (t1 in FIG. 2) of adsorption of the fuel vapor J.

As shown in FIG. 3(b), a graph that shows a relationship between a position in the flowing direction X of the fuel vapor J and an adsorption amount at the end of supply (immediately before adsorption saturation: time t2 in FIG. 2) at which a predetermined period has elapsed from the start t1 of supply of the fuel vapor J is a straight line having a predetermined inclination α on the downstream side (outlet side of the canister) in the flowing direction X. Note that an area S1 in FIG. 3(b) shows a total adsorption amount of the adsorbing layer K at this point in time. In contrast, in a case where the adsorbing rate of the adsorbing material is increased, the inclination α of the straight line on the downstream side (outlet side of the canister) in the flowing direction X at the same point in time increases as shown in FIG. 3(c).

In other words, the length L of an adsorption band that indicates a region in the flowing direction X in which the adsorbing material is adsorbing the fuel vapor J decreases as the adsorbing rate of the adsorbing material increases. Accordingly, the total adsorption amount (area S1 in FIG. 3(b) and area S2 in FIG. 3(c)) of the adsorbing layer K immediately before adsorption saturation (point in time shown in FIGS. 3(b) and 3(c)) increases as the adsorbing rate of the adsorbing material increases.

That is, the total adsorption amount of the fuel vapor J that can be adsorbed before adsorption saturation increases as the adsorbing rate of the adsorbing material used as the adsorbing layer K increases, and accordingly, the higher the adsorbing rate of the adsorbing material used as the adsorbing layer K is, the more preferable. However, an adsorbing material having a high adsorbing rate is expensive, and economic efficiency decreases when an adsorbing material with a high adsorbing rate is used in the whole adsorbing layer K.

Therefore, in the present invention, the casing is internally provided with: (i) the first adsorbing layer including the first adsorbing material as the adsorbing material and disposed at a position in contact with the air port at the other end in the flowing direction X of the fuel vapor J between the one end and the other end; and (ii) the second adsorbing layer including, as the adsorbing material, the second adsorbing material different from the first adsorbing material and disposed closer to the one end than the first adsorbing layer is in the flowing direction X, and in the adsorbing material, the first adsorbing material has a higher adsorbing rate with respect to the fuel vapor J than the second adsorbing material.

With this configuration, it is possible to reduce costs and realize a canister with high economic efficiency when compared with a case where all adsorbing materials used in the adsorbing layer K are the first adsorbing material having the high adsorbing rate.

Furthermore, it can be understood from the above description that there is a considerable relationship between the adsorbing rate of an adsorbing material provided on the downstream side in the flowing direction X of the fuel vapor J and the amount of increase in the total adsorption amount immediately before adsorption saturation, which is realized by reducing the length L of the adsorption band, but the adsorbing rate of an adsorbing material provided on the upstream side in the flowing direction X has little influence on the increase in the total adsorption amount.

Therefore, when the first adsorbing material having the high adsorbing rate is positively used in the first adsorbing layer that is in contact with the air port on the downstream side in the flowing direction X as in the characteristic configuration described above, an effect of improving adsorbing ability can be sufficiently exhibited, and consequently the casing can be downsized.

Note that the second adsorbing layer is on the side from which the fuel vapor J enters the adsorbing layer K, and accordingly, even when the adsorbing rate of the second adsorbing material included in the second adsorbing layer is increased, the length of the adsorption band immediately before adsorption saturation cannot be reduced, and the total adsorption amount of all the adsorbing materials included in the adsorbing layer K immediately before adsorption saturation does not increase. From this viewpoint, an adsorbing material that has relatively low adsorbing rate and is inexpensive is used as the second adsorbing material included in the second adsorbing layer in the present invention to improve economic efficiency.

As described above, a canister that can have high adsorbing ability and small size can be realized while maintaining economic efficiency by adjusting the position at which the length of the adsorption band of the adsorbing layer K during adsorption is reduced, in the flowing direction X in which the fuel vapor J flows within the canister while being adsorbed.

In another characteristic configuration of the canister, the first adsorbing material has an equilibrium adsorption capacity with respect to the fuel vapor that is larger than an equilibrium adsorption capacity of the second adsorbing material with respect to the fuel vapor.

When the equilibrium adsorption capacity of the first adsorbing material with respect to the fuel vapor is larger than the equilibrium adsorption capacity of the second adsorbing material with respect to the fuel vapor as in this characteristic configuration, economic efficiency can be improved compared with a case where all adsorbing materials used are relatively expensive adsorbing materials having a large equilibrium adsorption capacity. Moreover, it is possible to effectively increase the adsorption amount of the whole adsorbing layer immediately before adsorption saturation.

In another characteristic configuration of the canister, the first adsorbing material has an average particle diameter that is smaller than an average particle diameter of the second adsorbing material.

When the first adsorbing material has a small particle diameter as in this characteristic configuration, particles of the first adsorbing material have a large external surface area per unit volume, and accordingly, particles of the fuel vapor to be adsorbed are likely to reach the surface of the first adsorbing material. Furthermore, the fuel vapor that has reached the surface of the first adsorbing material moves through the first adsorbing material. When the first adsorbing material has a small particle diameter, the distance by which the fuel vapor moves through the first adsorbing material is short, and accordingly, the fuel vapor is likely to spread throughout the inside of the first adsorbing material. For these reasons, the adsorbing rate of the first adsorbing material increases, and therefore, it is possible to reduce the length of the adsorption band at the outlet of the adsorbing layer and increase the total adsorption amount of the whole adsorbing layer immediately before adsorption saturation as described above. Furthermore, the second adsorbing material has a relatively large average particle diameter, and accordingly, it is possible to suppress a pressure loss when the fuel vapor and air are passed through the canister.

In another characteristic configuration of the canister, the first adsorbing layer and the second adsorbing layer include a heat storage material including a phase change material that absorbs and releases latent heat according to a temperature change, the heat storage material has an average particle diameter of 0.9 mm or more and 1.6 mm or less, and the adsorbing material is activated carbon having a particle size distribution in which particles having a particle size of 0.71 mm or more and 2.36 mm or less constitute 95 wt % or more.

According to this characteristic configuration, the heat storage material having an average particle diameter of 0.9 mm or more and 1.6 mm or less is used, and activated carbon having a particle size distribution in which particles having a particle size of 0.71 mm or more and 2.36 mm or less constitute 95 wt % or more is used as the adsorbing material. Therefore, it is possible to increase an adsorption amount of the fuel vapor adsorbed on the adsorbing material and the heat storage material having small particle diameters particularly at the time when supplied fuel is adsorbed (or increase purging performance). Also, average particle diameters of the heat storage material and the adsorbing material are approximate to each other, and therefore, classification can be suppressed.

In another characteristic configuration of the canister, the average particle diameter of the heat storage material is 0.6 times or more and 1.3 times or less of an average particle diameter of the adsorbing material.

According to this characteristic configuration, the average particle diameters of the heat storage material and the adsorbing material are approximate to each other, and therefore, classification can be favorably suppressed.

In another characteristic configuration of the canister, the first adsorbing layer has a content rate of the heat storage material that is higher than a content rate of the heat storage material in the second adsorbing layer.

As described above, an adsorbing material with a high adsorbing rate is selected as the first adsorbing material included in the first adsorbing layer, and this increases an adsorption amount of the fuel vapor adsorbed on the first adsorbing material per unit time during adsorption of the fuel vapor, and also increases an amount of heat generated along with the adsorption.

When the content rate of the heat storage material in the first adsorbing layer is higher than the content rate of the heat storage material in the second adsorbing layer as in this characteristic configuration, heat generated in the first adsorbing layer along with adsorption can be favorably stored in the heat storage material included at the high content rate in the first adsorbing layer, and adsorbing ability of the first adsorbing material can be effectively maintained.

In another characteristic configuration of the canister,

the first adsorbing layer and the second adsorbing layer include a heat storage material including a phase change material that absorbs and releases latent heat according to a temperature change, and

the heat storage material included in the second adsorbing layer has a melting point that is lower than a melting point of the heat storage material included in the first adsorbing layer.

In the case where the fuel vapor to be adsorbed is supplied from the second adsorbing layer side as described above, the fuel vapor generates heat of adsorption sequentially from the upstream side while passing through the second adsorbing layer and the first adsorbing layer in this order, and a portion of the heat of adsorption sequentially moves toward the downstream side, and accordingly, the temperature of the second adsorbing layer is less likely to increase compared with the temperature of the first adsorbing layer.

When the melting point of the heat storage material included in the second adsorbing layer is lower than the melting point of the heat storage material included in the first adsorbing layer as in this characteristic configuration, it is possible to keep the temperature of the second adsorbing material included in the second adsorbing layer low particularly in an initial stage of supply of the fuel vapor to improve adsorptivity.

In another characteristic configuration of the canister, the heat storage material included in the first adsorbing layer has a melting point of 36° C. or higher, and the heat storage material included in the second adsorbing layer has a melting point lower than 36° C.

According to this characteristic configuration, in the case where the fuel vapor to be adsorbed is supplied from the second adsorbing layer side, the fuel vapor generates heat of adsorption sequentially from the upstream side while passing through the second adsorbing layer and the first adsorbing layer in this order, and a portion of the heat of adsorption sequentially moves toward the downstream side, and accordingly, the temperature of the second adsorbing layer is less likely to increase compared with the temperature of the first adsorbing layer as described above.

When the melting point of the heat storage material included in the first adsorbing layer is as high as 36° C. or higher as in this characteristic configuration, it is possible to keep the temperature of the second adsorbing material included in the second adsorbing layer low, particularly in the initial stage of supply of the fuel vapor to improve adsorptivity.

In another characteristic configuration of the canister,

the first adsorbing layer and the second adsorbing layer include a molded heat storage material molded from microcapsules in which a phase change material that absorbs and releases latent heat according to a temperature change is encapsulated, and

the molded heat storage material has a columnar shape and includes a first end surface on a first side of a column axis of the molded heat storage material and a second end surface on a second side of the column axis as viewed in a direction orthogonal to the column axis, and

an average value of R₁/rand R₂/r is 0.57 or more, where R₁ represents a length of a curved surface of a first edge portion, which connects the first end surface and a circumferential side surface around the column axis, in a radial direction of the first end surface, R₂ represents a length of a curved surface of a second edge portion, which connects the second end surface and the circumferential side surface, in a radial direction of the second end surface, and r represents a radius of a cross section of the molded heat storage material taken along the direction orthogonal to the column axis.

According to this characteristic configuration, the molded heat storage material has the columnar shape in which the average value of R₁/rand R₂/r is 0.57 or more, i.e., a shape including rounded corners, and therefore, miscibility of the molded heat storage material with the adsorbing material (dispersibility of the molded heat storage material in the adsorbing material) can be improved.

In particular, even when a relatively large amount of heat of adsorption is generated by the first adsorbing material included in the first adsorbing layer and having the high adsorbing rate, the heat of adsorption is favorably stored in the heat storage material, and accordingly, the adsorption amount during adsorption can be increased, and the heat can be favorably released when the fuel vapor is desorbed from the adsorbing material, and thus purging performance during purging can also be improved.

In the canister described above, the heat storage material preferably has a latent heat of 150 J/g or more and 200 J/g or less. Also, the heat storage material preferably has a bulk density of 0.40 g/mL or more and 0.60 g/mL or less.

According to these characteristics, in particular, even when a relatively large amount of heat of adsorption is generated by the first adsorbing material included in the first adsorbing layer and having the high adsorbing rate, the heat of adsorption is favorably stored in the heat storage material, and accordingly, the adsorption amount during adsorption can be increased, and the heat can be favorably released when the fuel vapor is desorbed from the adsorbing material, and thus purging performance during purging can also be improved.

In another characteristic configuration of the canister, a mass ratio of the heat storage material to the first adsorbing material in the first adsorbing layer is 0.15 or more and 0.80 or less, and a mass ratio of the heat storage material to the second adsorbing material in the second adsorbing layer is 0.05 or more and 0.50 or less.

In this characteristic configuration that has a precondition that the content rate of the heat storage material in the first adsorbing layer is higher than the content rate of the heat storage material in the second adsorbing layer, an adsorbing material that has a high adsorbing rate is selected as the first adsorbing material included in the first adsorbing layer as described above, and this increases an adsorption amount of the fuel vapor adsorbed on the first adsorbing material per unit time during adsorption of the fuel vapor, and also increases an amount of heat generated along with the adsorption.

When the mass ratio of the heat storage material to the first adsorbing material in the first adsorbing layer is 0.15 or more and 0.80 or less as in this characteristic configuration, the heat generated along with adsorption can be favorably stored in the heat storage material contained at the high mass ratio in the first adsorbing layer, and the first adsorbing material can effectively exhibit its adsorbing ability.

Also, the mass ratio of the heat storage material to the second adsorbing material in the second adsorbing layer is 0.05 or more and 0.50 or less, and thus it is possible to improve economic efficiency by reducing the mass ratio of the heat storage material to the second adsorbing material having a low adsorbing rate.

### BRIEF DESCRIPTION OF THE DRAWINGS

FIG. 1 is a schematic configuration diagram of an automotive vehicle including a canister according to an embodiment.

FIG. 2 is a conceptual diagram showing a function of the canister according to an embodiment.

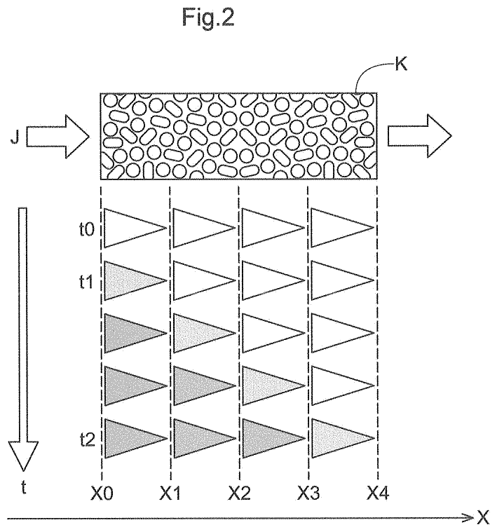

FIGS. 3(a)-(c) are conceptual diagrams showing a function of the canister according to an embodiment.

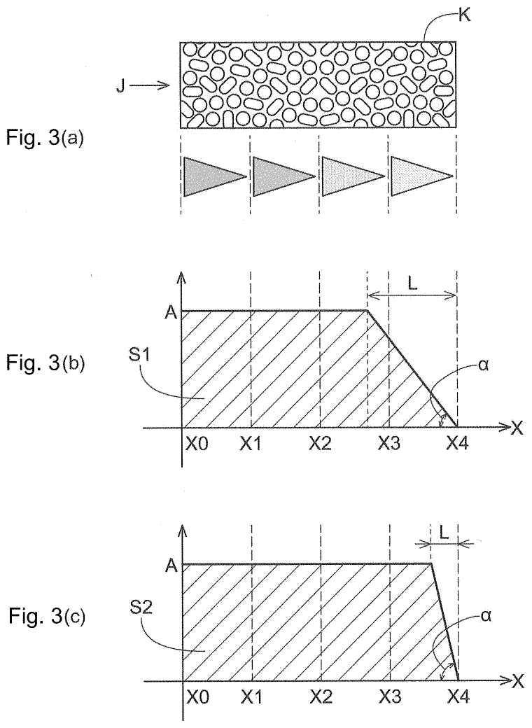

FIG. 4 is a schematic configuration diagram of a heat storage material according to an embodiment.

### DESCRIPTION OF THE INVENTION

A canister according to an embodiment of the present invention can have high adsorbing ability and small size while maintaining economic efficiency as a result of a position at which the length of an adsorption band of an adsorbing layer during adsorption is reduced being adjusted in a flowing direction in which fuel vapor flows within the canister while being adsorbed.

The following describes the canister according to the embodiment with reference to the drawings.

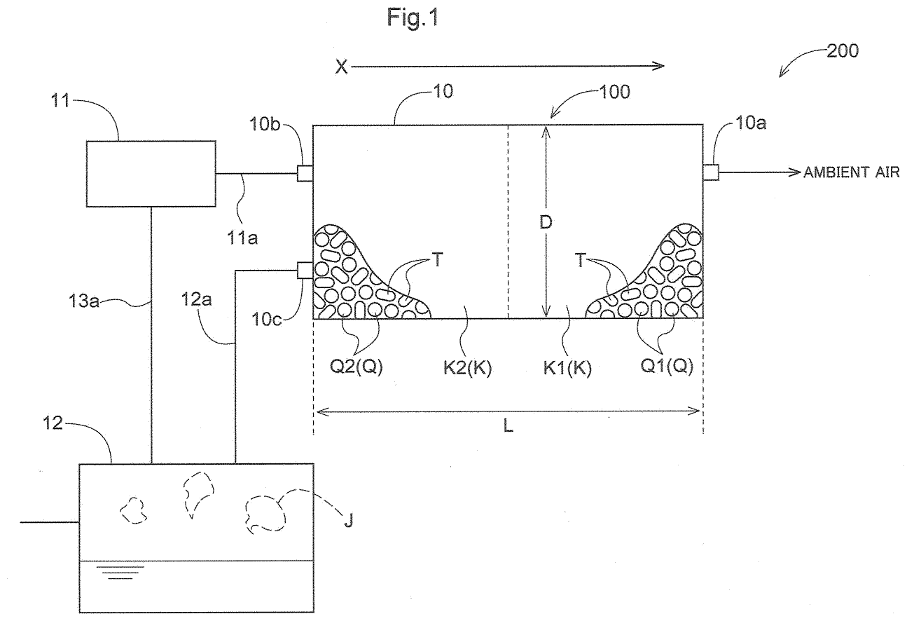

As shown in FIG. 1, a canister 100 according to the present embodiment includes a casing 10 that is internally provided with an adsorbing layer K capable of adsorbing fuel vapor J, and the canister 100 can be suitably applied to a commonly-known automotive vehicle. The automotive vehicle according to the present embodiment includes: a fuel tank 12 for storing fuel such as gasoline; the canister 100 configured to adsorb fuel vapor J vaporized in the fuel tank 12 particularly during fuel supply (during ORVR) and introduce the adsorbed fuel vapor J into an engine 11; and the engine 11 configured to obtain shaft output by combusting fuel including the fuel vapor J introduced from the canister 100 and combustion air in a combustion chamber (not shown).

As shown in FIG. 1, the canister 100 includes: the casing 10; a tank port 10c that communicates with the fuel tank 12 and is configured to receive fuel vapor J from the fuel tank 12; a purge port 10b configured to send fuel vapor J desorbed in the canister 100 during desorbing operation to the engine 11; and an air port 10a that communicates with ambient air. The tank port 10c and the purge port 10b are provided at one end in a flowing direction X, and the air port 10a is provided at another end in the flowing direction X. The purge port 10b communicates with the engine 11 via a purge flow path 11a. The engine 11 and the fuel tank 12 communicate with each other via a connecting path 13a.

The adsorbing layer K contains an adsorbing material Q that adsorbs and desorbs the fuel vapor J and a molded heat storage material T that is molded from microcapsules in which a phase change material that absorbs and releases latent heat according to temperature is encapsulated.

As shown in FIG. 1, the adsorbing layer K includes: a first adsorbing layer K1 that includes a first adsorbing material Q1 as the adsorbing material Q and is disposed at a position in contact with the air port 10a at the other end in the flowing direction X of the fuel vapor J between the one end and the other end; and a second adsorbing layer K2 that includes, as the adsorbing material Q, a second adsorbing material Q2 different from the first adsorbing material Q1 and is disposed closer to the one end than the first adsorbing layer K1 is in the flowing direction X. Note that in the present embodiment, the second adsorbing layer K2 is disposed at a position in contact with the purge port 10b and the tank port 10c at the one end of the casing, and the first adsorbing layer K1 and the second adsorbing layer K2 are separated by a predetermined separation film or the like.

Here, in an adsorbing material, the first adsorbing material Q1 has a higher adsorbing rate with respect to the fuel vapor J than the second adsorbing material Q2.

The molded heat storage material T is obtained by molding a heat storage material together with a binder into granules, for example. The heat storage material is obtained by encapsulating a phase change material that absorbs and releases latent heat according to a temperature change in microcapsules. It is possible to use a known heat storage material in the form of microcapsules such as that disclosed in JP 2001-145832A or and JP 2003-311118A.

The phase change material is constituted by an organic compound and an inorganic compound having a melting point of 10° C. or higher and 80° C. or lower, for example, and examples of the phase change material include: linear aliphatic hydrocarbons such as tetradecane, pentadecane, hexadecane, heptadecane, octadecane, nonadecane, eicosane, henicosane, and docosane; natural wax; petroleum wax; hydrated inorganic compounds such as LiNO₃.3H₂O, Na₂SO₄10H₂O, and Na₂HPO₄.12H₂O; fatty acids such as capric acid and lauric acid; higher alcohols having 12 to 15 carbon atoms; and esters such as methyl palmitate and methyl stearate. Two or more compounds selected from the above-listed compounds may be used together as the phase change material.

Microcapsules that are formed by using any of these compounds as a core material through a known method such as a coacervation method or an in-situ method (interfacial reaction method) can be used. A known material such as melamine, gelatin, or glass can be used to form outer shells of the microcapsules. The heat storage material in the form of microcapsules preferably has a particle diameter of about several micrometers to several tens of micrometers. If the microcapsules are too small, the proportion of the outer shells constituting the capsules increases, and the proportion of the phase change material that repeatedly melts and solidifies relatively decreases, and therefore, the amount of heat stored per unit volume of the powdery heat storage material decreases. On the other hand, if the microcapsules are too large, the capsules need to have certain strength, and accordingly, the proportion of the outer shells constituting the capsules increases, and the amount heat stored per unit volume of the powdery heat storage material decreases.

The powdery heat storage material is molded together with a binder into a substantially cylindrical shape to obtain a granular molded heat storage material T. Various binders can be used, but a thermosetting resin such as a phenol resin or an acrylic resin is preferably used from the viewpoint of thermal stability, stability against a solvent, and strength, which are required when the binder is used in the canister. The granular molded heat storage material T is mixed with the adsorbing material Q, which also has a granular shape, and the mixture is used to obtain a heat storing effect.

The molded heat storage material T preferably has a latent heat of 150 J/g or more and 200 J/g or less.

Various known adsorbing materials can be used as the adsorbing material Q. For example, activated carbon can be used as the adsorbing material Q. Granules individually molded or crushed to have predetermined dimensions can be used as the adsorbing material Q.

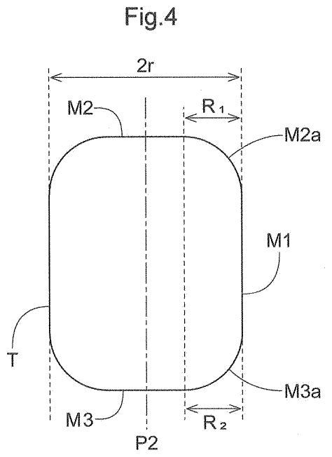

On the other hand, the molded heat storage material T that is molded into a columnar shape through extrusion molding as described above as shown in FIG. 4, for example, has a first end surface M2 on a first side of a column axis P2 and a second end surface M3 on a second side of the column axis P2 as viewed in a direction orthogonal to the column axis P2, and an average value of R₁/rand R₂/r is 0.57 or more, where R₁ represents the length of a curved surface of a first edge portion M2a, which connects the first end surface M2 and a circumferential side surface M1 around the column axis P2, in a radial direction of the first end surface M2, R2 represents the length of a curved surface of a second edge portion M3a, which connects the second end surface M3 and the circumferential side surface M1, in a radial direction of the second end surface M3, and r represents the radius of a cross section of the molded heat storage material T taken along the direction orthogonal to the column axis P2.

By adopting such a shape having rounded corners, it is possible to improve miscibility with the adsorbing material Q (dispersibility of the molded heat storage material T in the adsorbing material Q).

Note that the molded heat storage material T is shaped in such a manner that the length of the molded heat storage material T along the column axis P2 and the diameter of the cross section orthogonal to the column axis P2 do not differ very much from each other.

The molded heat storage material T and the granular adsorbing material Q preferably have the same size as far as possible or have approximately the same size in order to suppress separation of the molded heat storage material T and the adsorbing material Q from each other with the passage of time and appropriately secure a gas flow path.

However, the first adsorbing material Q1 preferably has an average particle diameter that is smaller than an average particle diameter of the second adsorbing material Q2. Furthermore, the molded heat storage material T preferably has an average particle diameter (diameter 2r of the cross section orthogonal to the column axis P2 of the columnar shape shown in FIG. 4) of 0.9 mm or more and 1.6 mm or less, and the adsorbing material Q preferably has an average particle diameter of 1.0 mm or more and 1.8 mm or less. Furthermore, both the first adsorbing material Q1 and the second adsorbing material Q2 used as the adsorbing material Q are preferably activated carbon having a particle size distribution in which particles having a particle size of 0.71 mm or more and 2.36 mm or less constitute 95 wt % or more.

Also, the average particle diameter (2r in FIG. 4) of the molded heat storage material T is preferably 0.6 times or more and 1.3 times or less of the average particle diameter of the adsorbing material Q.

Also, the first adsorbing material Q1 preferably has an equilibrium adsorption capacity with respect to the fuel vapor J that is larger than an equilibrium adsorption capacity of the second adsorbing material Q2 with respect to the fuel vapor J, and the first adsorbing layer K1 preferably has a content rate of the molded heat storage material T that is higher than a content rate of the molded heat storage material T in the second adsorbing layer K2.

The molded heat storage material T preferably has a bulk density of 0.4 g/mL or more and 0.6 g/mL or less. The adsorbing material Q desirably has a bulk density that is 0.2 times or more and 1.1 times or less of the bulk density of the molded heat storage material T, preferably 0.3 times or more and equal to or less than the bulk density of the molded heat storage material T, and more preferably 0.4 times or more and 0.9 times or less of the bulk density of the molded heat storage material T. If the bulk density of the adsorbing material Q largely differs from the bulk density of the molded heat storage material T, the adsorbing material Q or the molded heat storage material T that is heavier than the other moves downward within the casing when the canister is mounted in a vehicle or the like and vibration is applied to the canister, and separation of the adsorbing material Q and the molded heat storage material T progresses.

Furthermore, it is preferable that a mass ratio of the molded heat storage material T to the first adsorbing material Q1 in the first adsorbing layer K1 is 0.15 or more and 0.80 or less and a mass ratio of the molded heat storage material T to the second adsorbing material Q2 in the second adsorbing layer K2 is 0.05 or more and 0.50 or less. By adopting this configuration in which the mass ratio of the molded heat storage material T to the adsorbing material Q is higher in the first adsorbing layer K1 than in the second adsorbing layer K2, it is possible to suppress a temperature increase on the side of the canister that is close to ambient air and at which the temperature is likely to increase during fuel supply (ORVR) and thus prevent a reduction in adsorptivity.

Additionally, the molded heat storage material T included in the second adsorbing layer K2 preferably has a melting point that is lower than a melting point of the molded heat storage material T included in the first adsorbing layer K1, and it is preferable that the melting point of the molded heat storage material T included in the first adsorbing layer K1 is 36° C. or higher and the melting point of the molded heat storage material T included in the second adsorbing layer K2 is lower than 36° C. With this configuration, it is possible to keep the temperature of the second adsorbing material Q2 included in the second adsorbing layer K2 low particularly in an initial stage of supply of the fuel vapor J to improve adsorptivity.

As shown in FIG. 1, the casing 10 of the canister 100 preferably has dimensions and a shape designed such that a ratio L/D is 2.5 or less, where L represents the length of the adsorbing layer in the flowing direction X of the fuel vapor J in the casing 10, and D represents the diameter of a cross section of the casing 10, which is taken along a direction orthogonal to the flowing direction X of the fuel vapor J in the casing 10 and assumed to be a perfect circle. With this configuration, it is possible to suppress a pressure loss to a certain level or less even when the adsorbing material Q and the molded heat storage material T have small average particle diameters.

### Other Embodiments

(1) In the above embodiment, the canister 100 is intended to be used during fuel supply (ORVR), but the canister 100 can be used not only during fuel supply but also while the vehicle is parked, stopped, or traveling.

(2) In the above embodiment, a configuration example is described in which the adsorbing layer K includes the first adsorbing layer K1 and the second adsorbing layer K2, but the adsorbing layer K may further include an adsorbing layer other than the first adsorbing layer K1 and the second adsorbing layer K2.

Also, a configuration example is described in which the first adsorbing layer K1 and the second adsorbing layer K2 are separated from each other by the separation film, but a configuration is also possible in which the separation film is not provided.

Furthermore, a configuration is also possible in which the adsorbing material Q is provided between the first adsorbing layer K1 and the second adsorbing layer K2 in such a manner that the adsorbing rate increases toward the first adsorbing layer K1.

(3) In the above embodiment, the average particle diameter of the first adsorbing material Q1 is smaller than the average particle diameter of the second adsorbing material Q2.

However, the average particle diameter of the first adsorbing material Q1 may be approximate to or larger than the average particle diameter of the second adsorbing material Q2 as long as the first adsorbing material Q1 adsorbs the fuel vapor J at a higher adsorbing rate than the second adsorbing material Q2.

Also, instead of adopting the configuration in which the average particle diameter of the first adsorbing material Q1 is smaller than the average particle diameter of the second adsorbing material Q2, it is possible to adopt a configuration in which the first adsorbing material Q1 has a smaller specific surface area than the second adsorbing material Q2.

(4) In the above embodiment, a configuration is described in which the adsorbing layer K includes the molded heat storage material T, but a configuration is also possible in which the molded heat storage material T is not provided. Also, the molded heat storage material T may have a shape such as a rectangular tube-like shape, other than the cylindrical shape.

(5) In the above embodiment, the equilibrium adsorption capacity of the first adsorbing material Q1 with respect to the fuel vapor J is larger than the equilibrium adsorption capacity of the second adsorbing material Q2 with respect to the fuel vapor J.

However, the equilibrium adsorption capacity of the first adsorbing material Q1 with respect to the fuel vapor J may be approximate to or smaller than the equilibrium adsorption capacity of the second adsorbing material Q2 with respect to the fuel vapor J as long as the first adsorbing material Q1 adsorbs the fuel vapor J at a higher adsorbing rate than the second adsorbing material Q2.

(6) In the above embodiment, the content rate of the molded heat storage material T in the first adsorbing layer K1 is higher than the content rate of the molded heat storage material T in the second adsorbing layer K2.

However, the content rate of the molded heat storage material T in the first adsorbing layer K1 may be equal to or lower than the content rate of the molded heat storage material T in the second adsorbing layer K2.

Note that the configurations disclosed in the above embodiment (including the other embodiments, the same applies hereinafter) can be applied in combination with configurations disclosed in other embodiments as long as no contradiction arises. Also, the embodiments disclosed in the present specification are examples, and embodiments of the present invention are not limited to the disclosed embodiments, and it is possible to modify the embodiments as appropriate within a scope not departing from the object of the present invention.

The canister according to the present invention can be effectively used as a canister having high adsorbing ability and small size that can be realized while maintaining economic efficiency by adjusting the position at which the length of an adsorption band of the adsorbing layer during adsorption is reduced, in the flowing direction in which the fuel vapor flows within the canister while being adsorbed.

### DESCRIPTION OF REFERENCE SIGNS

10 Casing

10a Air port

10b Purge port

10c Tank port

100 Canister

J Fuel vapor

K Adsorbing layer

K1 First adsorbing layer

K2 Second adsorbing layer

M1 Circumferential side surface

M2 First end surface

M3 Second end surface

M2a First edge portion

M3a Second edge portion

P2 Column axis

PJ Purge gas

Q Adsorbing material

Q1 First adsorbing material

Q2 Second adsorbing material

T Molded heat storage material

X Flowing direction

1. A canister comprising:
a casing internally provided with an adsorbing layer that comprises an adsorbing material capable of adsorbing and desorbing fuel vapor;
a tank port provided at one end of the casing and configured to allow the fuel vapor to flow into the casing;
a purge port provided at the one end of the casing and configured to allow the fuel vapor to flow out of the casing;
an air port provided at another end of the casing and configured to allow air to flow into and out of the casing;
a first adsorbing layer provided inside the casing, and comprising a first adsorbing material as the adsorbing material, and wherein the first absorbing layer is disposed at a position in contact with the air port at the other end in a flowing direction of the fuel vapor between the one end and the other end; and
a second adsorbing layer provided inside the casing, and comprising a second adsorbing material different from the first adsorbing material, and wherein the second absorbing material is disposed closer to the one end than the first adsorbing layer is in the flowing direction, and
wherein the first adsorbing material adsorbs the fuel vapor at an adsorbing rate that is higher than an adsorbing rate of the second adsorbing material.

2. The canister according to claim 1,
wherein the first adsorbing material has an equilibrium adsorption capacity with respect to the fuel vapor that is larger than an equilibrium adsorption capacity of the second adsorbing material with respect to the fuel vapor.

3. The canister according to claim 1,
wherein the first adsorbing material has an average particle diameter that is smaller than an average particle diameter of the second adsorbing material.

4. The canister according to claim 1, wherein:
the first adsorbing layer and the second adsorbing layer comprise a heat storage material comprising a phase change material that absorbs and releases latent heat according to a temperature change,
the heat storage material has an average particle diameter of 0.9 mm or more and 1.6 mm or less, and
the adsorbing material is activated carbon having a particle size distribution in which particles having a particle size of 0.71 mm or more and 2.36 mm or less constitute 95 wt % or more.

5. The canister according to claim 4,
wherein the average particle diameter of the heat storage material is 0.6 times or more and 1.3 times or less of an average particle diameter of the adsorbing material.

6. The canister according to claim 4,
wherein the first adsorbing layer has a content rate of the heat storage material that is higher than a content rate of the heat storage material in the second adsorbing layer.

7. The canister according to claim 4,
wherein the first adsorbing layer and the second adsorbing layer comprise a heat storage material comprising a phase change material that absorbs and releases latent heat according to a temperature change, and
wherein the heat storage material in the second adsorbing layer has a melting point that is lower than a melting point of the heat storage material in the first adsorbing layer.

8. The canister according to claim 4,
wherein the heat storage material in the first adsorbing layer has a melting point of 36° C. or higher, and the heat storage material in the second adsorbing layer has a melting point lower than 36° C.

9. The canister according to claim 4, wherein:
the first adsorbing layer and the second adsorbing layer comprise a molded heat storage material molded from microcapsules in which a phase change material that absorbs and releases latent heat according to a temperature change is encapsulated,
the molded heat storage material has a columnar shape and has a first end surface on a first side of a column axis of the molded heat storage material and a second end surface on a second side of the column axis as viewed in a direction orthogonal to the column axis, and
an average value of R₁/r and R₂/r is 0.57 or more,
where R₁ represents a length of a curved surface of a first edge portion, which connects the first end surface and a circumferential side surface around the column axis, in a radial direction of the first end surface,
R₂ represents a length of a curved surface of a second edge portion, which connects the second end surface and the circumferential side surface, in a radial direction of the second end surface, and
r represents a radius of a cross section of the molded heat storage material taken along the direction orthogonal to the column axis.

10. The canister according to claim 4,
wherein the heat storage material has a latent heat of 150 J/g or more and 200 J/g or less.

11. The canister according to claim 4,
wherein the heat storage material has a bulk density of 0.40 g/mL or more and 0.60 g/mL or less.

12. The canister according to claim 4,
wherein a mass ratio of the heat storage material to the first adsorbing material in the first adsorbing layer is 0.15 or more and 0.80 or less, and a mass ratio of the heat storage material to the second adsorbing material in the second adsorbing layer is 0.05 or more and 0.50 or less.
